(19) United States
(12) Patent Application Publication
(10) Pub. No.: US 2013/0183418 A1
(43) Pub. Date: Jul. 18, 2013

(54) METHOD OF INHIBITION OF ENZYMATIC BROWNING IN FOOD USING A SULFINIC ACID COMPOUND

(71) Applicants: University of Florida Research Foundation, Inc., Gainesville, FL (US); Diane Schulbach, Gainesville, FL (US)

(72) Inventors: KURT F. SCHULBACH, GAINESVILLE, FL (US); MAURICE RUDOLPH MARSHALL, GAINESVILLE, FL (US)

(73) Assignee: UNIVERSITY OF FLORIDA RESEARCH FOUNDATION, INC., GAINESVILLE, FL (US)

(21) Appl. No.: 13/721,728

(22) Filed: Dec. 20, 2012

Related U.S. Application Data
(63) Continuation-in-part of application No. 12/936,819, filed on Feb. 2, 2011.
(60) Provisional application No. 61/046,622, filed on Apr. 21, 2008.

(51) Int. Cl. A23B 7/10

(52) U.S. Cl. CPC A23B 7/10
USPC 426/269; 426/654; 562/125

(57) ABSTRACT

A method of inhibiting enzymatic browning in food involves the contacting of a compound comprising a sulfinic acid with the food. The sulfinic acid comprising compound can be provided from solution, an extract, or in solid form to a food that can lose its appeal to a consumer due to browning, such as cut fruits and vegetables, seafood, or a beverage. The antibrowning agent can be applied to the food by spraying, dusting, dipping, or dissolving, depending upon the form of the food to which the agent is added. The compound comprising a sulfinic acid can comprise an alkysulfinic acid, an arylsulfinic acid, an alkylarylsulfinic acid, or an arylalkylsulfinic acid.

### CROSS-REFERENCE TO RELATED APPLICATIONS

This application is a continuation-in-part of U.S. patent application Ser. No. 12/936,819; filed Feb. 2, 2011, a U.S. national stage application of International Patent Application No. PCT/US2009/041245, filed Apr. 21, 2009, which claims the benefit of U.S. Provisional Application Ser. No. 61/046,622, filed Apr. 21, 2008, the disclosures of which are hereby incorporated by reference in their entireties, including any figures, tables, or drawings.

### BACKGROUND OF THE INVENTION

When selecting foods, a consumer typically considers its appearance, flavor, texture, and nutritional value. Of these four attributes, it is often only the appearance that can be employed for the selection of the food product. The appearance is particularly impacted by the observed color. For many foods the favorable color is typically that from naturally occurring pigments such as chlorophylls, carotenoids, and anthocyanins in a food as displayed in its mature state freshly removed from the environment in which it naturally matures, such as freshly picked ripe fruit or freshly caught seafood. With the progression of time, the color can change by the inclusion or substitution of pigments resulting from both enzymatic and non-enzymatic reactions. Enzymatic browning is one of the most important color reactions that affect fruits, vegetables, and seafood. This browning is catalyzed by the enzyme polyphenol oxidase (PPO) (1,2 benzenediol; oxygen oxidoreductase, EC1.10.3.1), which is a copper-containing enzyme that catalyzes the oxidation of o-diphenols to o-quinones. PPO is also referred to as phenoloxidase, phenolase, monophenol oxidase, diphenol oxidase and tyrosinase. Browning not only affects color, but can also adversely affect flavor and nutritional value.

Projected increases in fruit and vegetable markets require that enzymatic browning be understood and, more importantly, controlled. Enzymatic browning is devastating to the distribution of many exotic fruits and vegetables, particularly that of tropical and subtropical products. It has been estimated that more than 50 percent of losses during fruit distribution occur because of enzymatic browning. In addition to tropical and subtropical fruits and vegetables, products as diverse as lettuce, potatoes, sweet potato, breadfruit, yam, mushrooms, apples, avocados, bananas, grapes, and peaches are susceptible to significant losses during distribution due to browning. The closer to purchase by the consumer that browning occurs, the greater the economic losses incurred due to the storage and handling costs prior to this point in the distribution process. Therefore, controlling browning from harvest to consumer is critical for the maintenance of economic value to the agriculturist and food processor.

Polyphenol oxidase is important to the prevention of insects and microorganisms from attacking plants and is involved in the wound response of plants and plant products to insects, microorganisms, and bruising. A fruit's or vegetable's susceptibility to disease and infestation increases as it ripens because of a decline in its phenolic content. Phenoloxidase enzymes, endogenous to fruits and vegetables, catalyze production of quinones from phenolic constituents. These quinones subsequently undergo polymerization reactions that produce melanins, which exhibit both antibacterial and antifungal activity and assist in keeping the fruit or vegetable physiologically wholesome. Research on the antibacterial, anticancer and antioxidant nature of melanins has triggered considerable interest in enzymatic browning and has led to nutritional recommendations for increased consumption of fruits and vegetables. Convenience forms of these foods are particularly susceptible to enzymatic browning. Enzymatic browning does not occur in intact plant cells since phenolic compounds in cell vacuoles are separated from the polyphenol oxidase in the cytoplasm. Brown pigments form upon slicing, cutting, grating, pulping, or juicing. The organoleptic and biochemical characteristics of fruits and vegetables are altered by pigment formation. The rate of enzymatic browning in fruit and vegetables is governed by the active polyphenol oxidase content of the tissues, the phenolic content of the tissue, pH, temperature, and oxygen availability within the tissue. Attempts to control enzymatic browning have focused on the elimination of one or more of these governing factors.

Temperature control of browning is carried out by heating, blanching, or cooling, either refrigeration or freezing. Blanching is nutritionally disadvantageous, resulting in losses in vitamins, flavors, colors, texture, carbohydrates, and other water-soluble components. Blanching is also technically disadvantageous as it requires large amounts of water and energy and typically has waste disposal costs. Refrigeration adds costs throughout the distribution and retailing process, but is commonly employed for the prevention of browning in fruit, vegetables, and seafood. Freezing causes changes in texture and other freshness characteristics and can lead to decompartmentalization of certain enzymes, substrates, and/or activators by cell disruption facilitating enzyme activity upon thawing of the food.

Other treatments include dehydration, irradiation, high pressure treatment, super critical CO₂ treatment, ultrafiltration, and ultracentrifugation. Of these methods, dehydration affects the texture and flavor of food, irradiation requires high levels of radiation to denature the polyphenol oxidase enzyme, super critical CO₂ requires processing at pressures in excess of 50 atmospheres yet polyphenol oxidase is highly pressure resistant, and ultrafiltration and ultracentrifugation are processes that are effective only for liquids and that affect the nutritional value and require significant processing costs. For these reasons such methods do not provide a general cost effective method to control enzymatic browning.

Enzymatic browning has been addressed primarily by the use of chemical inhibiting agents. Such inhibitors can target the enzyme, the substrates (oxygen and polyphenols) or the brown products of the reaction. Inhibitors that act directly on polyphenol oxidase are often classified as members of two groups. The first group consists of metal ion chelators, and includes azide, cyanide, carbon monoxide, halide ions, and tropolone. The second group of inhibitors consists of aromatic carboxylic acids of the benzoic and cinnamic series which behave as competitive inhibitors of polyphenol oxidase by their structural similarity with phenolic substrates.

Substrate inhibitors remove either the oxygen or the phenolic substrate. The removal of oxygen can result in the promotion of anaerobic metabolic reactions in the food that can lead to breakdown with adverse effects on the flavor of the foods. Specific adsorbents can be used to remove phenolic compounds from foods. For example, cyclodextrins have been used for the removal of phenolic compounds from raw fruit and vegetable juices. Enzymatic modification of phenolic substrates has been examined for inhibition of polyphenol oxidase activity; however the cost of these enzymes is considered prohibitive towards the commercial development of this method. The products of diphenol oxidation, O-quinones, form dimers of the original phenol, which subsequently oxidize to form oligomers with varying color intensities. Ascorbic acid, thiol compounds, sulphites, and amino acids have displayed the capability of inhibiting dimer formation and oxidation by reducing O-quinones to O-diphenols or by formation of colorless addition products.

The use of browning inhibitors in food is restricted by considerations relevant to toxicity, wholesomeness, and their effect on taste, texture, and cost. Browning inhibitors have been classified by their primary mode of action as: (1) reducing agents; (2) acidulants; (3) chelating agents; (4) complexing agents; (5) enzyme inhibitors; and (6) enzyme treatments. Sulphites, considered reducing agents, are the most widely used inhibitors of enzymatic browning. Sulfites are subject to regulatory restrictions because of potential adverse health effects. Many reports have described allergic reactions in humans following the ingestion of sulphite-treated foods, often by hypersensitive asthmatics. Sulphites levels in food processing are based on their theoretical yields of sulfur dioxide. The Joint Expert Committee on Food Additives (JECFA) of the World Health Organization (WHO) and the Food and Agriculture Organization (FAO) recommend sulphite daily intake be limited to less than 0.7 mg sulphur dioxide per kg of body weight, and significant effort is being made to identify appropriate substitutes. Other widely used inhibitors include: reducing agents, such as, ascorbic acid, erythorbic acid, cysteine, synthetic antioxidants (such as butylated hydroxyanisole (BHA), butylated hydroxytoluene (BHT), tertiarybutyl hydroxyquinone (TBHQ) and propyl gallate (PG)); and plant based phenolic compounds (such as tocopherols, flavonoid compounds, cinnamic acid derivatives, and coumarins); acidulants, such as, citric, malic, and phosphoric acids; chelators, such as, sorbic acid, polycarboxylic acids (citric, malic, tartaric, oxalic, and succinic acids), polyphosphates (ATP and pyrophosphates); macromolecules (porphyrins, proteins), and EDTA; and enzyme inhibitors, such as, aromatic carboxylic acids, substituted resorcinols, halide salts, honey, amino acids, and proteins.

The search for effective affordable browning inhibitors continues. Inhibitors that are beneficial or, at least, non-toxic, and can be used at sufficient levels without adversely affecting the sensory characteristic of the foods, yet are cost effective, remain a need in the evolving food industry.

### BRIEF SUMMARY OF THE INVENTION

The invention involves a method of inhibiting enzymatic browning in a food where equivalents of hypotaurine, which are compounds comprising a sulfinic acid, are used as an inhibition agent for contacting with a food that would otherwise undergo enzymatic browning. The agent can be provided in a solution, for example, an aqueous solution, or as a solid. The agent can be provided at a level of about 10 to about 500 ppm by weight to the food to avoid its browning.

The agent can be contacted with the food by spraying, dipping, or dusting said agent onto surfaces of the food. Contacting can be carried out by dissolving the agent in the food. The food can be freshly cut, ground, sliced, grated, pulped or otherwise processed vegetable or fruit. The agent can be added to inhibit browning of a beverage such as wine.

### BRIEF DESCRIPTION OF THE DRAWINGS

FIG. 1 is a plot of the rate of color formation by the action of apple polyphenol oxidase on catechol in the presence (▪) and absence () of hypotaurine.

FIG. 2 is plots on a Sephadex G-25 gel filtration column of the absorption at 280 nm, left scale and the % inhibition for elution fractions of separated juice from Blue mussel after filtration and dialysis where the_% inhibition was collected every 15 minutes after 72 minutes of elution.

FIG. 3 shows HPLC traces of a separation of A) the juice from Blue mussel with the browning inhibitor identified by an arrow and where that inhibitor fraction is further separated by HPLC where B) is the trace of that separation under other conditions where the arrow identifies the elution fraction identified to contain the browning inhibitor.

FIG. 4 shows A) a plot of % inhibition by the HPLC fraction of FIG. 3B) of apple PPO as a function of inhibitor concentration and B) the bleaching of the enzymatically brown colored solution by the inhibitor by the absorbance decrease at 420 nm over time with times of additional aliquot of inhibitor additions indicated on the plot.

### DETAILED DESCRIPTION OF THE INVENTION

The present invention is directed to the use of a compound comprising a sulfinic acid, or its equivalent, as an inhibitor of enzymatic browning in foods. In one embodiment of the invention, sulfinic acid comprising compound is added to vegetable or fruit surfaces exposed by cutting, grinding, slicing, grating, pulping or other processing to inhibit the rate of browning at the surface exposed by the processing. In one embodiment of the invention, the sulfinic acid comprising compound can be delivered to a food from aqueous solution. In another embodiment of the invention, the sulfinic acid comprising compound can be added as a solid to a liquid food, such as a vegetable or fruit juice, wine or other beverage. In another embodiment of the invention, the sulfinic acid comprising compound can be added to shrimp or other seafood to inhibit browning.

Hypotaurine is a natural compound formed by catabolism of cysteine where the mammalian enzyme cysteine dioxygenase CDO converts cysteine to cysteine sulfinic acid followed by decarbonylation to hypotaurine (2-aminoethane sulfinic acid), which can be subsequently oxidized to taurine. Hypotaurine can be produced synthetically. One method is disclosed in Ohsumi et al. U.S. Pat. No. 5,856,563 and Ohsumi et al. U.S. Pat. No. 5,679,845 as an industrially viable process. Hypotaurine can be in the foint of an equivalent, including a salt of hypotaurine. A hypotaurine salt can be in the form of an alkali or alkali-earth metal 2-aminoethane sulfinate salt. A hypotaurine salt can be in the form of an ammonium salt of 2-aminoethane sulfinic acid. A hypotaurine salt can be in the form of a 2-ammoniumethane sulfinic acid salt of a strong acid, for example, as a salt of hydrochloric acid. The equivalents of hypotaurine can be employed with a food that is capable of converting the equivalent to hypotaurine and in some instances result in the conversion of the equivalent over an extended period of time. Equivalents of hypotaurine can be any precursor to hypotaurine that can generate hypotaurine readily upon contact with the food, or can be an analog of hypotaurine that is non-toxic and can inhibit browning, yet does not generate hypotaurine upon contact with the food. Hypotaurine equivalents include cysteine sulfinic acid and mono and di N-substituted hypotaurine where the alkyl or, independently, alkyl groups are C1 to C8 alkyl which can be straight chained or branched. According to embodiments of the invention, hypotaurine equivalents that can be employed for the inhibition of browning are substituted or unsubstituted C1-C8 alkylsulfinic acids, C6-C10 arylsulfinic acids, C7-C18 alkylarylsulfinic acids, or C7-C18 arylalkylsulfinic acids.

In an embodiment of the invention, a C1-C8 alkylsulfinic acid, C6-C10 arylsulfinic acid, C7-C18 alkylarylsulfinic acid or C7-C18 arylalkylsulfinic acid acts as an antibrowning agent for the food. For example, the C1 alkylsulfinic acid, methane sulfinic acid, or methylsulfinic acid inhibit browning efficiently in the manner of hypotaurine. Also, the C6 aryl sulfinic acid, phenylsulfinic acid, inhibits browning efficiently in the manner of hypotaurine. The sulfinic acids can be used as their free acid or as a salt of the acid, for example, an ammonium salt, a sodium salt, a potassium salt, or any other alkali or alkali-earth salt of the sulfinic acid. The alkylsulfinic acid, arylsulfinic acid, alkylarylsulfinic acid, or arylalkylsulfinic acid can be an ester of the sulfinic acid, for example, an ethyl ester of the sulfinic acid. The alkylsulfinic acid, arylsulfinic acid, alkylarylsulfinic acid, or arylalkylsulfinic acid can be substituted on the alkyl, aryl, alkylaryl, or arylalky portion of the sulfinic acid compound. For example, the compound can be substituted with amino, hydroxy, carboxylic acid, thiol, sulfinic acid, sulfonic acid, or other substituent, and, where the substituent is an acid, it can be in the form of a salt of the acid. The unsubstituted or substituted C1-C8 alkylsulfinic acid, C6-C10 arylsulfinic acid, C7-C18 alkylarylsulfinic acid, or C7-C18 arylalkylsulfinic acid can be used where it is 10 to 500 ppm of the food upon addition.

Hypotaurine is a component of an extract from a foodstuff that contains significant amounts of hypotaurine. Foodstuff high in hypotaurine includes clam, oyster, mussels, squid, and octopus. As hypotaurine is a small molecule, it can be separated with other small molecule components of appropriate foodstuff from cells, proteins and other large molecules by a variety of methods practiced by those skilled in the art. Methods such as microfiltration, nanofiltration, ultrafiltration, size exclusion chromatography, affinity chromatography, ion-exchange chromatography and a host of other methods can be used, separately or in combination, depending upon the nature of the hypotaurine extract source.

A solid food, to be contacted with a sulfinic acid comprising compound, or its equivalent for browning inhibition, can be dipped or otherwise submerged in a solution containing the sulfinic acid comprising compound, sprayed with an aerosol containing the sulfinic acid comprising compound in solution, or dusted with a solid containing sulfinic acid comprising compound. When solutions are used the solvent can be water or any ingestible solvent, for example, ethanol or a vegetable oil. The viscosity of the solution containing hypotaurine, or its equivalent, can be thickened using any natural or synthetic thickener, including starches, sugars, or polyethyleneoxides. For a liquid food, such as a juice, wine or other beverage, solid hypotaurine, or its equivalent, can be dissolved in the liquid at low levels such that no significant alteration of the taste or other sensory factors occurs upon addition. The concentration of the sulfinic acid comprising compound or its equivalent on or within a food contacted can be less than 500 ppm based on the weight of the sulfinic acid comprising compound. For example, the sulfinic acid comprising compound or its equivalent can be 400, 300, 250, 200, 150, 100, 90, 80, 70, 60, 50, 40, 30, 25, 20, 15, or 10 ppm by weight of the food after inclusion.

When a contacting solution is used, the solution can contain any concentration of the sulfinic acid comprising compound or its equivalent that permits the contacted food to display a desired level of sulfinic acid comprising compound or its equivalent. For example, an aqueous solution can be saturated in the sulfinic acid comprising compound or its equivalent at a temperature of contacting, or can be contained at a lower concentration that allows a sufficient level of the sulfinic acid comprising compound to be achieved on or within the food. For example, a nounal room temperature solution, about 25° C., can have a sulfinic acid comprising compound concentration of about 100 mg/mL or less. A solution of about 100° C. can be used where the sulfinic acid comprising compound concentration is much higher, for example 200 mg/mL and the food can be partially or fully blanched while contacting with the sulfinic acid comprising compound solution. By use of a very volatile solvent, a sulfinic acid comprising compound equivalent can be contacted by a solution where the solvent does not persist in the food. For example, the sulfinic acid comprising compound equivalent can be dissolved in ethanol.

In one embodiment of the invention, the sulfinic acid comprising compound, or its equivalent, can be used in conjunction with a second chemical additive for the inhibition of browning. For example, the sulfinic acid comprising compound can be used in combination with sulfites, such that the sulfite level can be maintained at or below an acceptable level of safety. For example, sulfite levels can be below the level of 10 ppm that requires warnings on a food label, with the sulfinic acid comprising compound included at a level where the combination inhibits browning, but the two agents would not inhibit browning if used separately at these levels. The sulfinic acid comprising compound can be included with: ascorbic acid; erythorbic acid; cysteine; synthetic antioxidants, such as, butylated hydroxyanisole (BHA), butylated hydroxytoluene (BHT), tertiarybutyl hydroxyquinone (TBHQ) and propyl gallate (PG); and plant based phenolic compounds, such as, tocopherols, flavonoid compounds, cinnamic acid derivatives, and coumarins; acidulants, such as, citric, malic, and phosphoric acids; chelators such as sorbic acid, polycarboxylic acids, such as, citric, malic, tartaric, oxalic, and succinic acids; polyphosphates, such as, ATP and pyrophosphates; macromolecules, such as, porphyrins and proteins; EDTA; and enzyme inhibitors, such as, aromatic carboxylic acids, substituted resorcinols, halide salts, honey, amino acids, and proteins.

### Materials and Methods

### Materials

Hypotaurine was purchased from Sigma Aldrich, St. Louis, Mo., USA.

Acetone powder containing apple polyphenol oxidase was prepared from Red Delicious apples. Cored and peeled apple pieces (200 g) were homogenized in a precooled blender along with 400 mL cold acetone (−20° C.) for 1 min and then filtered through Whatman No. 1 filter paper. The residue was extracted 3 times with 200 mL cold acetone and the resulting white powder was dried at room temperature, vacuum sealed in commercial plastic bags, and stored at −20° C. until needed. Crude PPO enzyme from the acetone powder was reconstituted in 0.1 M KH₂PO₄/Na₂HPO₄, pH 7.2 Containing 1% Triton X-100 (Bio-Rad Laboratories, Hercules, Calif.) using modified procedures of Murata et al. “Relationship between apple ripening and browning—changes in polyphenol content and polyphenol oxidase”, Journal of Agricultural and Food Chemistry 1995, 43 (5), 1115-21 and Yemenicioglu et al. “Heat inactivation kinetics of apple polyphenoloxidase and activation of its latent form”, Journal of Food Science 1997, 62 (3): 508-10. Acetone powder (1 g) was added to 50 mL of refrigerated 0.1 M KH₂PO₄/Na₂HPO₄, pH 7.2 buffer containing 1% TritonX-100 (Bio-Rad Laboratories, Hercules, Calif.) and the mixture was stirred for 20 min at 4° C. The suspension was centrifuged at 1200×g for 30 min, then filtered through glass wool and stored at −20° C. where it remained stable for at least 1 month.

### Hypotaurine Extract

Frozen mussels, farm-raised in Canada, were thawed and the free liquid was retained. Following filtration, the extract was dialyzed using Spectra/Por CE 500 MWCO membrane (Spectrum Labs. Inc., Rancho Dominguez, Calif.) with 3 changes of distilled water over a 24 hr period. Following dialysis, the extract was filtered through a 0.45 μm nylon membrane filter and then 30 mL aliquots were applied to a 38.5×2.5 cm Sephadex G-25-80 size-exclusion column (Sigma, St. Louis, Mo.) using 0.02 M phosphate buffer, pH 5.7 as the mobile phase. The active fraction was collected and freeze-dried to concentrate the inhibitor. Just prior to an experiment, freeze dried inhibitor was reconstituted with DI water to one-sixth original volume. The presence of hypotaurine was confirmed by mass spectroscopy.

### Evaluation of Browning Inhibition

A standard reaction mixture for evaluation of browning inhibition where the hypotaurine comprising solution was a mussel extract, consisted of 2.45 mL of 0.1 sodium acetate/acetic acid buffer, pH 5.5, 0.2 ml mussel extract (or additional pH 5.5 buffer for a control run for comparison), 0.3 mL of 0.5 M catechol (Sigma, St. Louis, Mo.) and 0.05 mL of enzyme extract. The percent inhibition was calculated with the following formula: I=100*(A-B)/A, where A and B are the greatest initial linear rate of the control and the test system respectively.

### Hypotaurine Activity

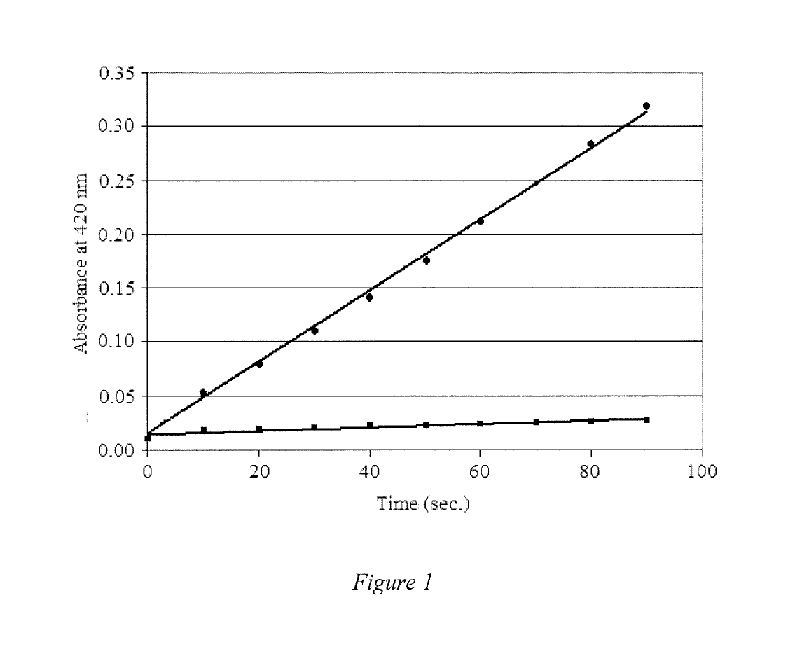

Polyphenol oxidase activity was measured by monitoring the increase in color (absorbance at 420 nm) in a reaction mixture with catechol as a substrate. FIG. 1 shows the rapid increase in color formation in the control sample and very slow color formation when hypotaurine was added to the reaction mixture. From the data in FIG. 1, the inhibition of polyphenol oxidase by 90 ppm of hypotaurine was calculated to be 97 percent with a 30 fold decrease in the rate of browning. The mussel extract was employed in a similar manner and inhibition was calculated to be 93 percent with a 14 fold decrease in the rate of browning.

Although not limited by the mechanism of browning inhibition, the reduction in color formation in the reaction mixture appears to be at least partially due to the inhibition of the polyphenol oxidase enzyme. Using the mussel extract that contained high levels of hypotaurine, oxygen levels in a reaction mix containing catechol and the mussel extract consumed significantly less oxygen, suggesting that at least one mode of inhibition was enzyme inhibition, as the enzyme consumes oxygen during the conversion of catechol to o-quinone. Oxygen consumption was monitored using the OxyMicro oxygen meter. The addition of the mussel extract to the reaction mixture lowered the slope of the oxygen consumption curve from −0.914 to −0.652, clearly indicating that the mussel extract was inhibiting the enzyme. Hypotaurine can also provide inhibition of color by forming colorless addition products with highly reactive quinones in addition to enzyme inhibition. The addition products of hypotaurine with quinones can inhibit degradation of anthocyanins pigments, in addition to inhibiting browning.

### Materials

Frozen Blue mussels (Mytilus edulis) were acquired from a local seafood market. Red Delicious apples, Russet potatoes and mushrooms were purchased at a supermarket. Catechol (Certified), acetone (Certified), and HPLC grade acetonitrile, methanol, 1-propanol and phosphoric acid were purchased from Fisher Scientific. Hypotaurine, sodium methanesulfinate and benzene sulfinic acid were purchased from Sigma-Aldrich Co.

### Preparation of Mussel Inhibitor

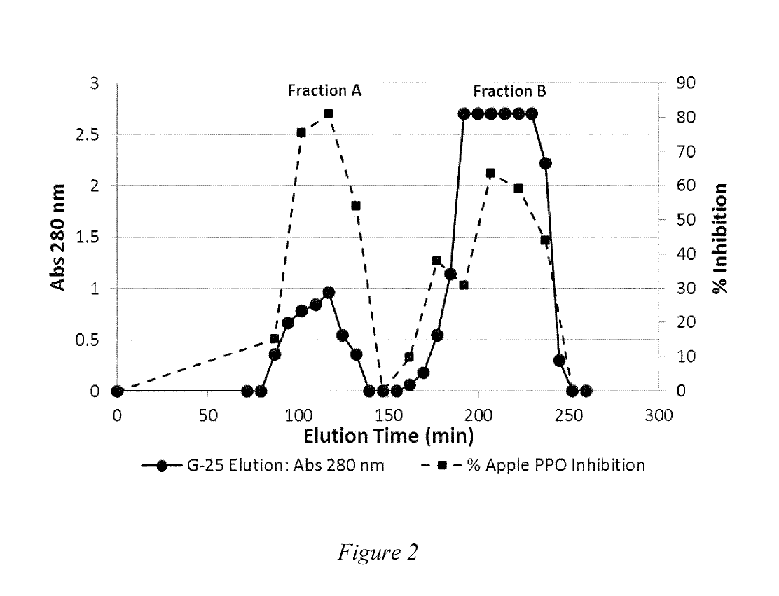

Packages of Blue mussels were thawed under running water and the juice surrounding the mussels was removed and collected. The mussels were shucked, the contents pressed through EMD Chemical Inc. 3P Miracloth, combined with the juice and filtered through a Whatman GF/B glass microfiber filter under vacuum. The filtered juice mixture was filtered a second time through a 0.45μ Whatman nylon filter under vacuum, and was dialyzed using a Spectra/Por CE 500 Da MWCO dialysis tubing 3 changes of deionized water at 4° C. for 24 h. This dialysate (crude inhibitor) was used for determining initial inhibition with apple PPO. Once inhibition was established, the dialysate was filtered through a 0.45μ Whatman nylon filter. Thirty mL of the final filtrate was applied to a column (Sephadex G-25-80, 2.5 cm D×38 cm L), and the column eluted with 0.02 M acetate buffer, pH 5.5 at a flow rate of 0.3 mL/min, and collected as two fractions A and B that displayed inhibition, as indicated in FIG. 2.

### Preparation of Plant PPO

Apple, potato and mushroom were cut into small pieces and approximately 200 g each were homogenized in a pre-chilled blender at a high speed for 1 min with 400 mL acetone (−20° C.). The blended suspension was filtered through Whatman No. 1 filter paper and the filtered residue after evaporation of residual acetone drying at room temperature was placed in the blender and blended with an additional 200 mL of cold acetone. The filtration and re-extraction were repeated two additional times. The residue after the 4^{th} extraction was left overnight under vacuum to dry and then placed in vacuum storage bags at −20° C. until needed.

PPO extraction was performed on the stored residue. One g of residue was mixed with 50 mL 0.1M phosphate buffer, pH 7.2, with stirring for 30 min at 4° C. and then centrifuging at 12,000 g for 30 min in a Beckman Coulter Optima Centrifuge. The supernatant was filtered through Pyrex glass wool and stored in microcentrifuge tubes at −20° C. until needed.

### Polyphenol Oxidase Assay

PPO activity was determined in the presence or absence of mussel inhibitor using a spectrophotometric assay at 420 nm and 25° C. The reaction mixture consisted of 2.45 mL of 0.1 M sodium acetate-acetic acid buffer, pH 5.5, 0.3 mL of 0.5 M catechol, 0.05 mL of PPO and 0 to 0.2 mL of fractions A or B inhibitor or control buffer. Percent inhibition was calculated from the greatest initial linear rates with inhibitors to that of the control in the standard reaction mixture.

### High Performance Liquid Chromatography (HPLC)

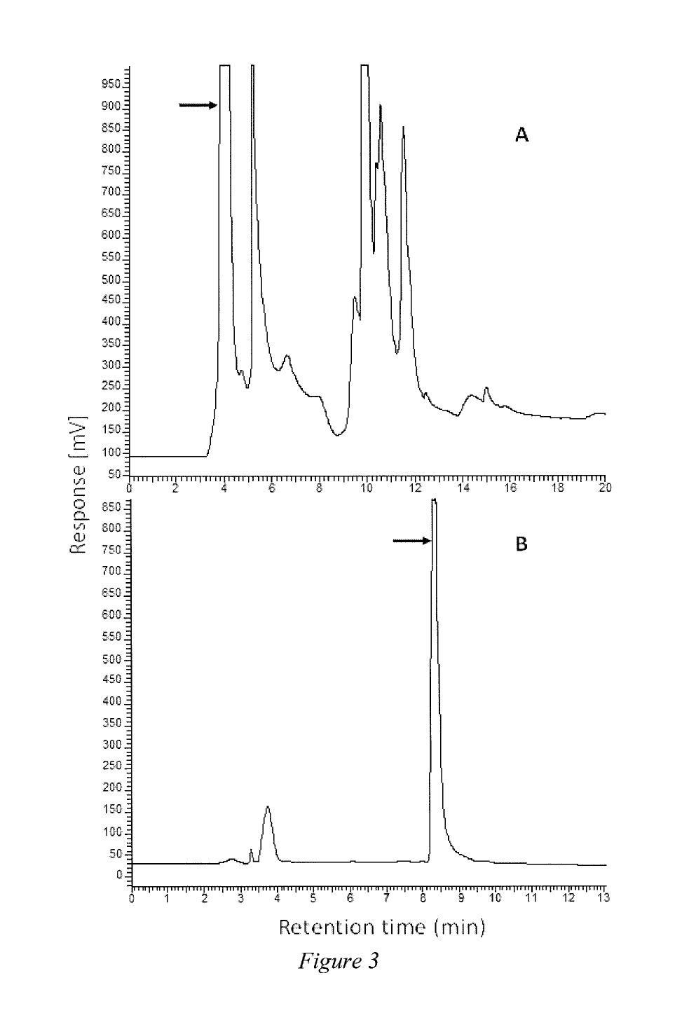

All HPLC methods with the exception of those run for mass spectral analysis were performed on a Perkin Elmer HPLC system consisting of a series 200 autosampler, series 200 LC pump, and series 235C diode array detector. Fraction B from the G-25 column was concentrated using a Labconco model 5 freeze-dryer equipment (Labconco Co. Kansas City, Mo.) and reconstituted with 8 mL of methanol:water (75:25 v/v). Approximately, 50-70 replicate 100 μL injections of this were run on the HPLC system. The conditions were column: Agilent Zorbax SB-C18 (5 μm, 4.6×250 mm, Agilent Technologies); mobile phase: solvent A, 0.1 M phosphoric acid, pH 2.5, solvent B, 0.1 M phosphoric acid, pH 2.5 in 50% acetonitrile; gradient elution: 100% A to 100% B over 6 min, then hold for 2 min, 100% B to 100% A over 4 min, then hold for 8 min for equilibration; flow rate: 0.8 mL/min; detection: 215 nm. Inhibitor was collected in the fractions between 3.5-3.8 min, as indicated in FIG. 3A. Approximately, 5-7 mL of the collected sample was dialyzed as described previously using only one change of deionized water. This was then freeze dried as previously described and brought up to 1-2 mL with methanol:water (75:25 v/v).

This inhibitor fraction was then applied to a C-18 column (Alltech Econosil, 5 μm, 4.6×250 mm) with the following conditions: solvent A, 1% propanol in acetonitrile, solvent B, 1% propanol in water; gradient elution: 100% A, then inject (50 μL) sample and hold for 2 min, ramp to 70% B over 12 min, ramp to 100% A over 6 min, then hold for 10 min for equilibration; flow rate: 0.8 mL/min; detection: 215 nm. Inhibitor was collected in the fractions representing the center of the peak (approx. 8.3-8.5 min) until the 1-2 mL sample was completely injected, as shown in FIG. 3B. The combined 8.3-8.5 min fractions were dried under N₂ gas and reconstituted with buffer (0.1 M sodium acetate-acetic acid buffer, pH 5.5) for assaying or further characterization.

Mass spectra analyses of the inhibitor were performed. HPLC/UV/MS analyses were performed with an Agilent (Agilent Technologies) 1100 series binary pump, Phenomenex Synergi 4μ Hydro-RP 80 Å (2×150 mm; 4 μm) plus C18 guard column (2 mm×4 mm), Agilent 1100 G1314A variable wavelength detector (254 or 215 nm monitored) and Thermofinnigan LCQ quadruple ion trap mass spectrometer operated with an electrospray ionization source. A number of different gradients and mobile phases were used. Of particular interest was the use of a C18 column with a “normal” phase gradient. The “normal” phase gradient C18 HPLC utilized a mobile phase A of 1% isopropanol in water and mobile phase B of 1% isopropanol in acetonitrile. The normal phase gradient was: 100% B for 0-2 min, linear ramp to 5% B over 45 min; hold at 5% B for 13 min; linear gradient to 100% B over 30 min and hold for 30 min at 100% B. A number of different MSⁿ methods were used; typically, collision-induced dissociation (CID) MS/MS data were obtained at 37.5% CID energy and q-CID of 0.25 or at 45% CID energy and q-CID of 0.3.

High resolution mass spectrometry (HRMS) analyses were performed on an Agilent 6210 time-of-flight mass spectrometer (TOFM) operated with an electrospray ionization source. Samples were introduced via flow injection with an Agilent 1200 series binary pump.
Purification and Characterization of Inhibitor from Blue Mussel

The crude mussel juice extract after initial dialysis inhibited apple PPO by 84±3.09% (control rate_{avg}, 0.27±0.02 ΔA_{420 nm}/min; 3 extractions with 2 replicates, n=6). Inhibition for over 25 samples varied from 65-84% for most batches of crude juice after initial dialysis with the exception of one batch which showed only 45% inhibition. The dialyzed juice was then placed on a G-25 Sephadex column and the following elution profile was observed, as shown in FIG. 2). Two fractions, A and B, showed inhibition for apple PPO; inhibiting the enzyme by 80% and 62%, respectively. Based on the elution profile, inhibitors from mussel showed a large molecule fraction, Fraction A, eluting close to the void volume and a small molecule fraction, Fraction B, eluting late in the profile. Previous PPO inhibition studies from insects showed PPO inhibitors were either peptides or proteins. Both fractions, A and B, were tested for PPO inhibition using apple, mushroom, and potato PPO. The inhibitor activity prior to the G-25 column was 84±1.6% for apple, 18.6±0.12% for mushroom, and 18.5±0.9% for potato. Fraction A from the G-25 column showed 80.8±0.5%, 0%, and 1.8±0.85% inhibition for apple, mushroom and potato PPO, respectively, while Fraction B inhibited PPO by 58.1±1.01% (apple), 32.4±3.54% (mushroom), and 44.3±0.97% (potato). Fraction B showed broader inhibition for various PPOs, so its inhibitor was further identified using apple PPO for testing inhibition.

Though Fraction B was expected to contain an inhibitor that is a small protein or peptide, when purified by HPLC, as described above, the inhibitor activity was retained in 500 Da MWCO dialysis tubing but lost using 1,000 Da MWCO dialysis tubing. Samples after dialysis analyzed for any amino acid sequence displayed two major peaks, identified as histidine and an unknown inhibitor that is not a small protein/peptide. Further purification of the inhibitor was performed using HPLC, as described above. The first chromatographic run provided an inhibitor eluting between 3.3 to 4.3 min. The center of that elution was collected, which showed an inhibition of 80-96%, which was further separated by HPLC. A fraction containing inhibitor eluted between 8.3 to 8.8 min in the second chromatography separation, where the center of the collection peak displayed inhibition, after solvent removal of 74-90%. This fraction was further evaluated for inhibition and identification using LC-MS.

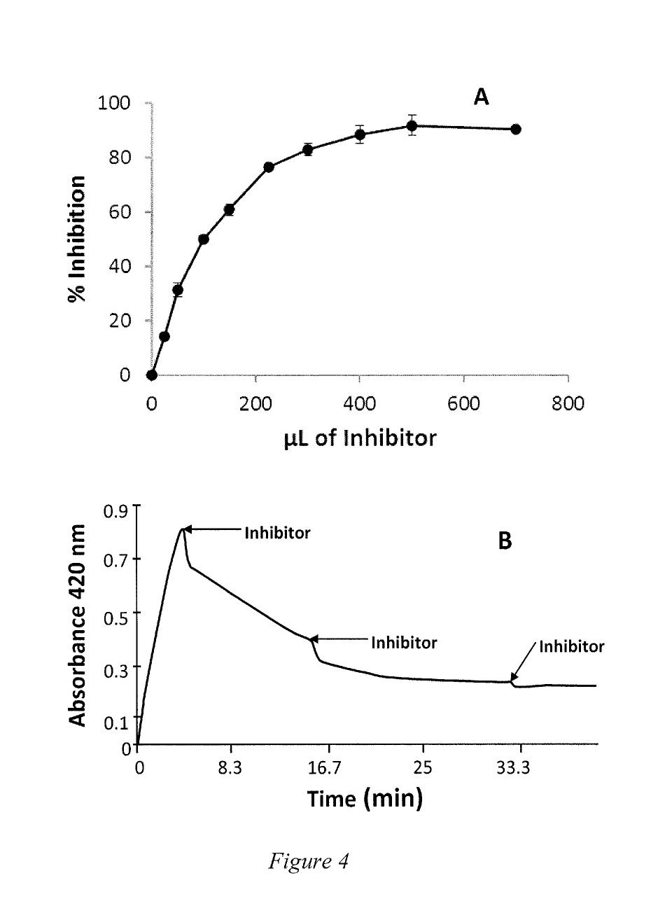

The collected inhibitor fraction from the second chromatographic run was evaluated for percent inhibition of apple PPO versus concentration, as shown in FIG. 4A, which indicated that the percent inhibition observed was fairly linear with inhibitor concentration in the reaction mixture to 150 μL/3 mL and then increased more gradually to a concentration of about 500 μL/3 mL with a maximum inhibition of about 92%. When the inhibitor was added after color formation, bleaching occurred to the color reaction mixture, as shown in FIG. 4B. After an initial rapid lowering of absorbance at 420 nm, absorbance continued to decline over time. Further additions of inhibitor did not appreciably decrease the absorbance.

The inhibitor fraction from the second HPLC run was analyzed by HPLC-MS using a reverse phase gradient C18 HPLC/254 nm UV/ESI-MS, wherein a number of compounds were detected. The inhibitor eluted essentially in the void volume at 100% aqueous mobile phase, resulting in poor sensitivity with difficult MS data for interpretation as a number of compounds eluted in the void volume. Subsequently, a more purified inhibitor fraction that was analyzed with a “normal” phase gradient C18 HPLC described above gave a MW of 109 for the inhibitor. Subsequent flow injection/ESI-TOF-HRMS of a more purified inhibitor fraction resulted in a molecular formula of C2H7N1O2S1, which was identified as hypotaurine from the fragmentation and combination patterns of the mass spectrum, given in Table 1, below, and confirmed by adding pure hypotaurine to the extracts and performing chromatography.

TABLE 1
Data for flow injection/ESI-TOF-HRMS of the blue mussel inhibitor.

| | | Theoretical | Detected | Delta |
|---|---|---|---|---|
| ESI Polarity | Ion | m/z | m/z | (ppm) |
| (+)ESI-MS | [M + H]+ | 110.027 | 110.0266 | −3.64 |
| | [M − H + 2Na]+ | 153.9909 | 153.9904 | −3.25 |
| (−)ESI-MS | [M − H]− | 108.0125 | 108.0122 | −2.78 |
| | [(M − H) + (M − H + | 239.0142 | 239.014 | −0.84 |
| | Na)]− | | | |

In addition to hypotaurine, other sulfinic acid comprising compounds were tested for inhibition using apple PPO, as indicated in Table 2, below. All sulfinic acid comprising compounds showed inhibition towards apple PPO. At the low concentration of 67.5 μM, approximately 7 ppm by weight, inhibition was around 20-30%, and as the concentration increased, inhibition increased to a maximum of 100%. The lowest inhibition at the highest concentration of 500 μM, about 50 ppm by weight, was hypotaurine at 89% inhibition compared to methane and benzene sulfinic acids at 100%. Taurine, a sulfonic acid and product of the intermediate hypotaurine, did not inhibit apple PPO: Activity (n=3) for a control was 0.24±0.02 ΔA_{420 nm}/min while the activity at 67.5, 250 and 500 μM sulfinic acid was 0.23±0.04, 0.25±0.01 and 0.23±0.01 ΔA_{420 nm}/min, respectively.

TABLE 3
Percent inhibition of apple PPO using sulfinic
acid comprising compounds.

| Compound | Concentration [μM] | Average % Inhibition* |
|---|---|---|
| Hypotaurine | 67.5 | 39.1 ± 4.48 |
| | 250 | 80.0 ± 14.90 |
| | 500 | 89.8 ± 7.65 |
| Methane Sulfinic Acid | 67.5 | 33.7 ± 0.69 |
| | 250 | 96.8 ± 0.69 |
| | 500 | 99.8 ± 0.11 |
| Benzene Sulfinic Acid | 67.5 | 20.9 ± 16.15 |
| | 250 | 98.5 ± 1.28 |
| | 500 | 100.0 ± 0.08 |

*Data are averages ± standard deviations, n = 6.

All patents, patent applications, provisional applications, and publications referred to or cited herein, supra or infra, are incorporated by reference in their entirety, including all figures and tables, to the extent they are not inconsistent with the explicit teachings of this specification.

It should be understood that the examples and embodiments described herein are for illustrative purposes only and that various modifications or changes in light thereof will be suggested to persons skilled in the art and are to be included within the spirit and purview of this application.

We claim:

1. A method of inhibiting enzymatic browning in a food comprising the steps of:
providing an agent comprising a compound comprising sulfinic acid or an equivalent thereof; and
contacting said food with said agent.

2. The method of claim 1, wherein said agent comprises a solution.

3. The method of claim 2, wherein said solution comprises an aqueous solution.

4. The method of claim 1, wherein said agent comprises a solid.

5. The method of claim 1, wherein said step of providing comprises delivering said agent at a level of 10 to 500 ppm of said food.

6. The method of claim 1, wherein said compound comprising a sulfinic acid comprises a C1-C8 alkylsulfinic acid, C6-C10 arylsulfinic acid, C7-C18 alkylarylsulfinic acid, C7-C18 arylalkylsulfinic acid, or any salt thereof.

7. The method of claim 6, wherein said compound comprising a sulfinic acid is methylsulfinic acid or phenylsulfinic acid.

8. The method of claim 6, wherein said compound comprising a sulfinic acid comprises a C1-C8 alkylsulfinic acid, C6-C10 arylsulfinic acid, C7-C18 alkylarylsulfinic acid, C7-C18 arylalkylsulfinic acid, or any salt thereof is substituted with at least one amino, hydroxy, carboxylic acid, thiol, sulfinic acid, sulfonic acid, or any combination thereof.

9. The method of claim 1, wherein said step of contacting comprises spraying, dipping, or dusting said agent onto surfaces of said food.

10. The method of claim 1, wherein said step of contacting comprises dissolving said agent in said food.

11. The method of claim 1, wherein said food comprises a freshly cut, ground, grated, pulped or otherwise processed vegetable or fruit.

12. The method of claim 1, wherein said food comprises a beverage.

13. The method of claim 12, wherein said beverage comprises wine.

14. The method of claim 1, further comprising the step of providing a second enzymatic browning inhibitor.

15. The method of claim 14, wherein said second enzymatic browning inhibitor comprises sulfites, ascorbic acid, erythorbic acid, cysteine, butylated hydroxyanisole (BHA), butylated hydroxytoluene (BHT), tertiarybutyl hydroxyquinone (TBHQ), propyl gallate (PG), tocopherols, flavonoid compounds, cinnamic acid derivatives, coumarins, citric acid, malic acid, phosphoric acids, sorbic acid, tartaric acid, oxalic acid, succinic acids, ATP, pyrophosphates, porphyrins, EDTA, aromatic carboxylic acids, substituted resorcinols, halide salts, honey, amino acids, or any combination thereof.

16. An agent for inhibiting enzymatic browning, comprising a compound comprising sulfinic acid or an equivalent thereof.

17. The agent of claim 16, wherein said compound comprising a sulfinic acid comprises a C1-C8 alkylsulfinic acid, C6-C10 arylsulfinic acid, C7-C18 alkylarylsulfinic acid, C7-C18 arylalkylsulfinic acid, or any salt thereof.

18. The agent of claim 16, wherein said compound comprising a sulfinic acid is methylsulfinic acid or phenylsulfinic acid.

19. The agent of claim 17, wherein said C1-C8 alkylsulfinic acid, C6-C10 arylsulfinic acid, C7-C18 alkylarylsulfinic acid, C7-C18 arylalkylsulfinic acid, or any salt thereof is substituted with at least one amino, hydroxy, carboxylic acid, thiol, sulfinic acid, sulfonic acid, or any combination thereof.

20. The agent of claim 16, wherein said agent comprises a liquid, a solid or a solid suspended in a liquid.

21. The agent of claim 16, further comprising at least one additional enzymatic browning inhibitor, wherein said additional enzymatic browning inhibitor comprises sulfites, ascorbic acid, erythorbic acid, cysteine, butylated hydroxyanisole (BHA), butylated hydroxytoluene (BHT), tertiarybutyl hydroxyquinone (TBHQ), propyl gallate (PG), tocopherols, flavonoid compounds, cinnamic acid derivatives, coumarins, citric acid, malic acid, phosphoric acids, sorbic acid, tartaric acid, oxalic acid, succinic acids, ATP, pyrophosphates, porphyrins, EDTA, aromatic carboxylic acids, substituted resorcinols, halide salts, honey, or amino acids.
